(19) United States
(12) Patent Application Publication
(10) Pub. No.: US 2005/0289447 A1
(43) Pub. Date: Dec. 29, 2005

(54) Systems and methods for generating and storing referential links in a database

(75) Inventors: Brent L. Hadley, Kent, WA (US); Patrick J. Eames, Newcastle, WA (US); Susan C. Chew, Issaquah, WA (US)

Correspondence Address: BLACK LOWE & GRAHAM, PLLC, 701 FIFTH AVENUE, SUITE 4800, SEATTLE, WA, 98104, US

(73) Assignee: The Boeing Company, Chicago, IL (US)

(21) Appl. No.: 10/879,387

(22) Filed: Jun. 29, 2004

(51) Int. Cl. G06F 17/21

(52) U.S. Cl. 715/501.1

(57) ABSTRACT

Systems and methods for the generation of referential links according to predetermined association rules are disclosed. In one embodiment, the system includes a first data storage location operable to store at least one data structure and having data elements extracted from at least one written document. A second data storage location stores at least one business rule that defines an association between data elements in the data structure. A processor is coupled to the first data storage location and the second data storage location to process the data elements in the data structure and generate referential links corresponding to the business rule. In another embodiment, a method includes selecting at least one business rule that describes a selected attribute of a written document. The data structure is processed to generate a referential link corresponding to the business rule and stored in a database.

### FIELD OF THE INVENTION

This invention relates generally to systems and methods for information management, and more particularly, to systems and methods for the generation of referential links according to predetermined association rules.

### BACKGROUND OF THE INVENTION

In recent years, commercial enterprises have increasingly transferred documents of various types into information databases that may be directly accessed by a user. Information databases offer a level of convenience to a user because they do not require the user to physically access volumes containing indexed information, or to access drawing files, product information, and the like. Similarly, the use of information databases is advantageous to commercial enterprises because it allows significant cost savings. For example, the information database generally supports “paperless” operation, thus reducing paper and printing costs. The use of information databases also largely eliminates the substantial floor space requirements generally associated with document libraries, filing cabinets and drawing files, which are typically used to store the documents. Most importantly, the use of information databases significantly reduces the amount of time a user must devote to acquiring needed documents.

As information databases increase in size, however, ease of access to a desired document has correspondingly increased in difficulty. Although an information database may store data in a highly efficient manner, currently available methods for searching and extracting useful information from the database have generally not kept pace with the growth of information databases. In particular, current methods for searching and extracting data typically do not permit an intuitive and judgmental interpretation of information stored in the database. Instead, current information databases are generally configured in a prescribed hierarchy of topics, so that current methods for searching and extracting the desired data require that a user manually navigate through various levels in the database to find the information of interest.

Although hyperlinks may assist a user in locating information of interest, the hyperlinks are typically not formulated by the user and thus usually encode the human judgment of another. Accordingly, hyperlinks may not provide the flexibility that a user desires. As an alternative, a user may utilize a Boolean text search engine to obtain the desired information in a more direct manner, but even well-crafted Boolean text searches often fail to locate the desired information, and may instead lead to the retrieval of many documents that are of little value to a user.

One example of an information database is the Portable Maintenance Aid (PMA) that is offered by The Boeing Company of Chicago, Ill. The PMA includes aircraft maintenance information in a readily accessible format so that maintenance personnel may conveniently obtain desired maintenance information and view the information on a viewing device. FIG. 1 is a graphical view of a portion of the PMA 10 that includes a main directory 12 that lists the electronic documents that are available for a particular aircraft model, including an electronic version of an aircraft illustrated parts catalog (AIPC), an electronic version of an aircraft maintenance manual (AMM), as well as other documents that may be required to properly maintain the aircraft. Upon selecting a particular document 13 from the main directory 12, a user then selects a desired portion 14 of the selected document 13 from various sub-menus (not shown) or otherwise initiates movement within the selected document 13 until the desired portion 14 of the selected document 13 is viewed. A user may then access illustrations 15 associated with the portion 14 through hyperlinks, or by otherwise moving through the selected document 13.

Although the PMA 10 affords significant advantages and constitutes an advance in the state of the art, a PMA user is constrained to move within the PMA 10 according to predetermined routes that are established by the author. Accordingly, if the user needs to view other information that is not included in the portion 14 for comparison purposes, the user must print a copy of the portion 14, and then locate the other information to make the required comparison. Alternately, the user may open separate viewing windows on the viewing device, and toggle between the two windows so that the comparison may be made. In many cases, however, information from intervening documents may be required before the comparison can be made, which introduces further complications and requires additional time.

Therefore, there is an unmet need in the art for apparatus and methods that permit a user to form a desired association between documents that allows the user to directly and conveniently access the documents.

### SUMMARY OF THE INVENTION

The present invention comprises systems and methods for the generation of referential links according to predetermined association rules. In one aspect, a system for generating referential document links includes a first data storage location operable to store at least one data structure having data elements extracted from at least one written document. A second data storage location stores at least one business rule that defines an association between data elements in the data structure. A processor is coupled to the first data storage location and the second data storage location that is configured to process the data elements in the data structure and generate at least one referential link corresponding to the at least one business rule. In another aspect, a method for generating referential document links includes selecting at least one business rule that describes a selected attribute of a written document. The data structure is processed to generate at least one referential link corresponding to the selected business rule. The referential link is then stored in a database.

### BRIEF DESCRIPTION OF THE DRAWINGS

The preferred and alternative embodiments of the present invention are described in detail below with reference to the following drawings.

FIG. 1 is a graphical view of a portion of the content in a database in accordance with the prior art; and,

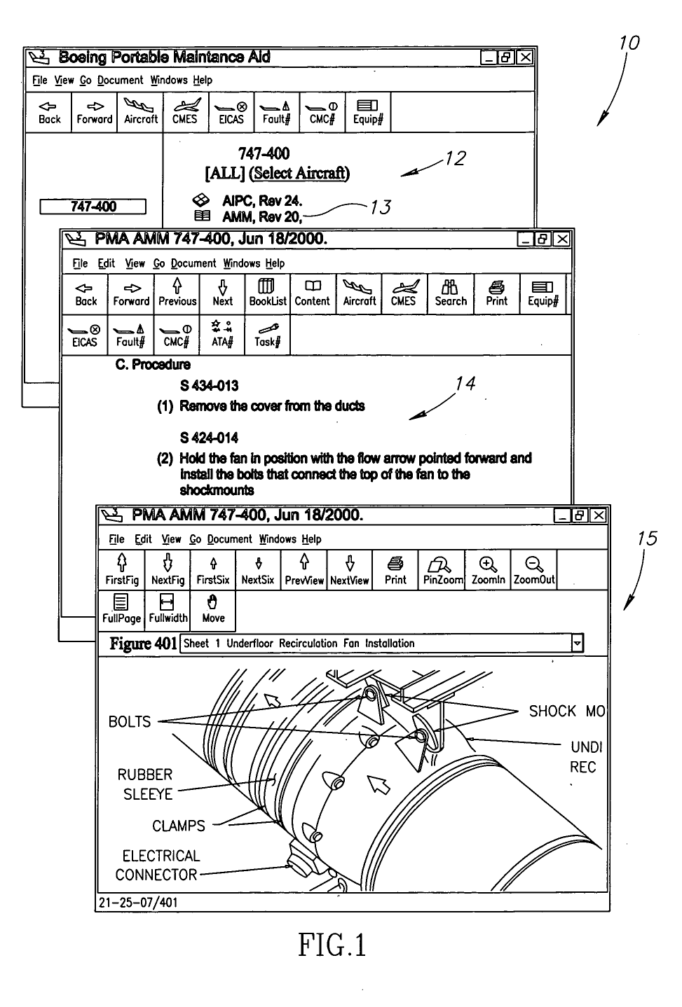

FIG. 2 is a block diagram of a system for generating referential document links according to an embodiment of the invention;

FIG. 3 is an example of a written document that is accessible by electronic means and drafted according to a formatting convention;

FIG. 4 is an example of a data structure generated from the document of FIG. 3; and

FIG. 5 is a flow chart of a method of generating one or more referential document links from a data structure using one or more predetermined business rules, according to another embodiment of the invention.

### DETAILED DESCRIPTION OF THE INVENTION

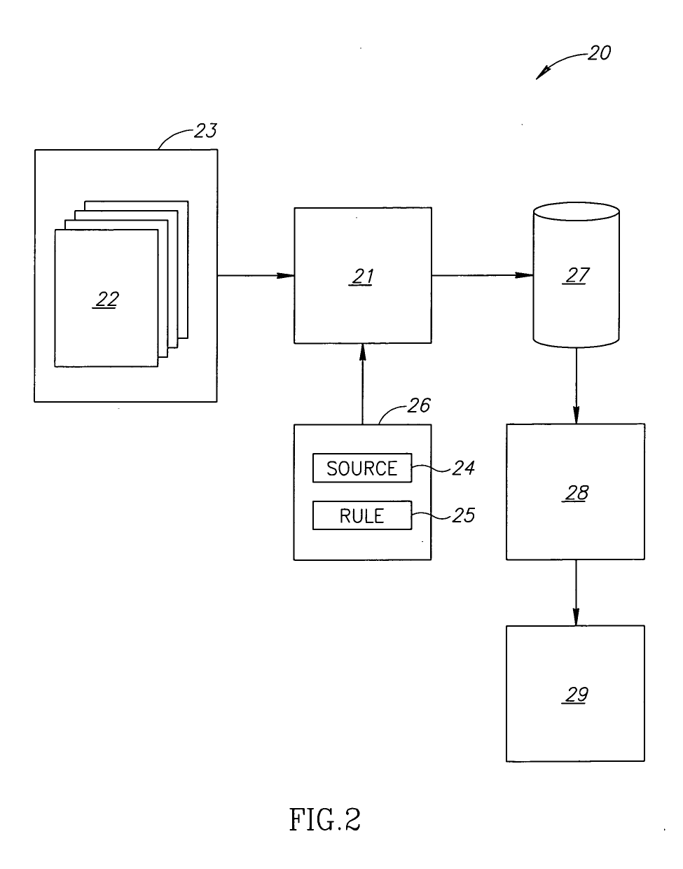

1 The present invention relates to systems and methods for information management, and, more particularly, to systems and methods for the extraction of information from a database using predetermined association rules. Many specific details of certain embodiments of the invention are set forth in the following description and in FIGS. 2 through 5 to provide a thorough understanding of such embodiments. One skilled in the art, however, will understand that the present invention may have additional embodiments, or that the present invention may be practiced without several of the details described in the following description.

FIG. 2 is a block diagram of a system 20 for generating referential document links according to an embodiment of the invention. The system 20 includes a processor 21 operable to identify and extract referential document links, as will be described in detail below, and generally includes any programmable electronic device configured to receive programming instructions and input data, and to process the data according to the programming instructions. The link processor 21 is coupled to a storage location 23 that permits one or more data structures 22 to be accessed by the processor 21. The processor 21 is also coupled to a storage location 26 that permits source information 24 and business rule information 25 to be accessed by the processor 21. The source information 24 and the business rule information 25, as well as the data structures 22, will be described in further detail below. The storage locations 23 and 26 may comprise memory locations within the processor 21. Alternately, the storage locations 23 and 26 may comprise portions of a mass-storage device configured to store relatively large amounts of data, such as hard disk drive, or other similar devices. The storage locations 23 and 26 may further be comprised of a memory device configured to receive a removable memory medium, such as a floppy disk, an optical disk, a magnetic tape a flash memory device, or other well-known memory media.

The processor 21 is further coupled to a database 27 and is configured to store the referential document links generated by the processor 21. Accordingly, the database 27 may also comprise a memory location within the processor 21, or may also comprise a separate mass-storage device, such as hard disk drive, or a memory device configured to receive a removable memory medium, such as a floppy disk, an optical disk, a magnetic tape, a flash memory device, or other well-known removable memory media. The database 27 is coupled to a link processor 28 that is operable to access the referential document links stored in the database 27, to interpret the links and to perform proper actions according to a meaning of the link when the link is actuated. The link processor 28 is further coupled to a peripheral device 29 that allows a user to view one or more selected document links that are retrieved from the database 27. Accordingly, the peripheral device 29 may include a display screen, or other similar viewing devices. Alternately, the peripheral device 29 may include a printing device that allows a tangible copy to be generated. Additionally, the link processor 28 may be operable to incorporate referential links stored in the database 27 into other selected documents.

With continued reference to FIG. 2, the data structure 22 will now be described in detail. The data structure 22 is a document having a well-defined data format that is drafted in a structured language, as is well known in the art. For example, in some embodiments, the data structure 22 includes data elements extracted from written documents that are in electronic form, such as electronic documents in the well-known portable document format (PDF), or from written documents in a tangible form. In the present disclosure, it is understood that a written document refers to a document that is readily understood by a user, such as a set of user-readable instructions, a reference manual, and the like. Alternately, the written documents may be unintelligible to the user.

In one particular embodiment, the data structure 22 includes an extended markup language (XML) document having semantic tags that describe data elements that are extracted from the written documents. The XML document may be generated by automated means, such as by a method tailored to produce the XML document from a PDF document, as is disclosed in detail in our co-pending U.S. application Ser. No. ______, entitled “DOCUMENT INFORMATION MINING TOOL”, filed Apr. 30, 2004, under attorney docket number BOEI-1-1257, which application is incorporated by reference. Alternately, the XML document may be created from a conventional printed page by electronically scanning the page to produce a scanned image and processing the scanned image using an optical character recognition (OCR) program to produce the document in electronic form. The XML document may then be created by the method disclosed in the referenced application. The XML document may also be manually created by identifying selected data elements in a source document and drafting the XML document according to well-known XML authorship rules. In any case, the data structure 22 may include, for example, elements extracted from a drawing that shows an exploded view of an assembly and/or a parts identification list that corresponds to the drawing, a flowchart that defines a process, or any other document of a technological nature. Alternately, for example, the data structure 22 may include elements extracted from a financial balance sheet, a financial prospectus, a corporate policies manual, or other similar documents. The data structure 22 may also be comprised of elements drawn from various published documents that are generally available to the public, such as newspapers, magazines, technical articles, and the like. Accordingly, it is understood that the data structure 22 may be generated from a wide variety of written documents.

Still referring to FIG. 2, the source information 24 and the business rule information 25 stored in the storage location 26 will now be described. Since the data structures 22 may include data from many various written documents, a user may prefer that processing of the data structures 22 be limited to a selected group of the structures 22. Accordingly, the source information 24 includes information regarding which data structures 22 are to be processed by the processor 21. The business rule information 25 may be comprised of any suitably well-defined property exhibited by a written document. Accordingly, and within the context of a manufacturing enterprise, for example, the business rule information 25 may simply include a description of a single part as expressed in a component part number. Other forms of business rule information 25 may be broader in scope, and include, for example, a selected portion of a written document format such as a title block on the written document. The business rule information 25 may further include, for example, the format of text within the title block of the document. Accordingly, it is understood that many other document attributes may be identified as business rule information 25, as will be described in detail below.

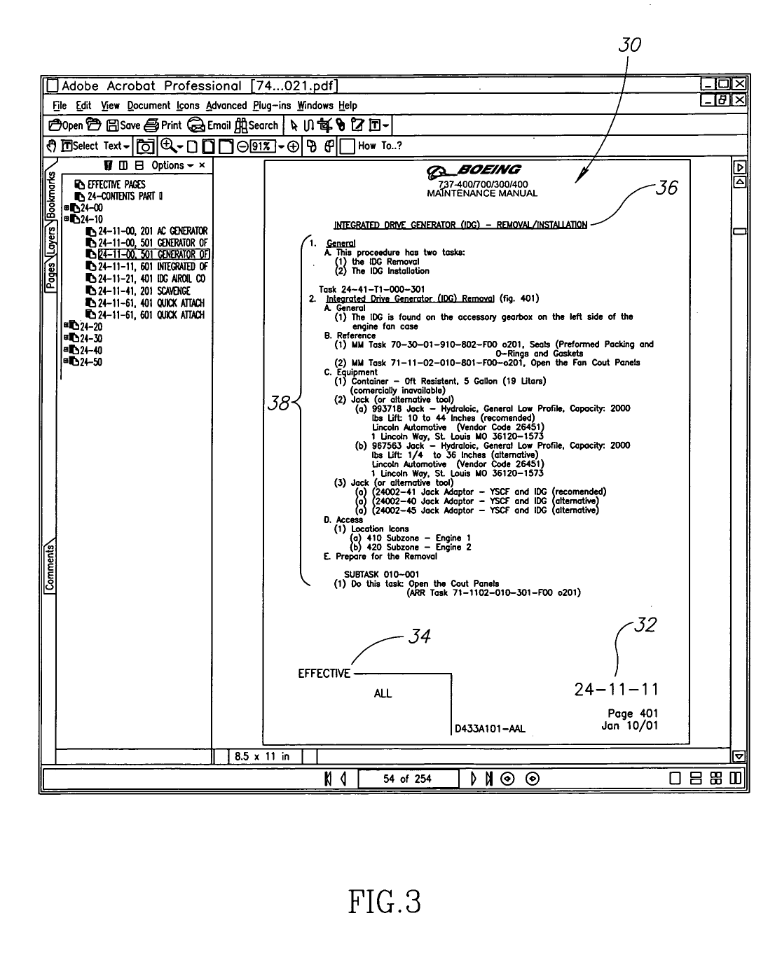

Turning now to FIG. 3, an example of a written document 30 that is accessible by electronic means is shown. In the present disclosure, it is understood that a written document refers to a document that is formatted in conventional and readable form that is readily understandable by a user of the document. The document 30 is a single page extracted from an aircraft maintenance manual (AMM). The document 30 is thus formatted according to conventional rules established by the Air Transport Association, Inc. (ATA) of Washington, D.C., and accordingly includes a plurality of document indicators that are readily identifiable, which may pertain to the placement of text or other information in the document 30. For example, a location designator 32 is positioned by convention in a lower corner of the document 30. The location designator 32 also includes format indicators that are similarly established by convention. In particular, the designator 32 includes a chapter number (e.g. “24”) that is understood by convention to refer to the electrical power system of an aircraft. Other numbers comprising the designator 32 refer to a section (e.g. “11”) and a subject (e.g. “11”) to fully describe a task associated with a selected component in the aircraft electrical system.

Still other rules are present and identifiable in the document 30. For example, the document 30 includes an effectivity block 34 positioned in an opposing lower corner of the document 30 that includes information regarding the applicability of the document 30 to a particular aircraft, which may be identified as a placement indicator. The document 30 also includes a title 36 located by convention in an upper portion of the document 30 that provides a general description of the acts described in a body 38 of the document 30. The title 36 also exhibits underlining, which may also be extracted as a font indicator. Accordingly, a plurality of distinct rules related to the placement of text in the document 30, the format of a text portion in the document 30, or a font used in a text portion in the document 30 may be identified and extracted from the document 30. The indicators thus identified may be encoded in the data structure 22 (of FIG. 2) as will be described in detail below.

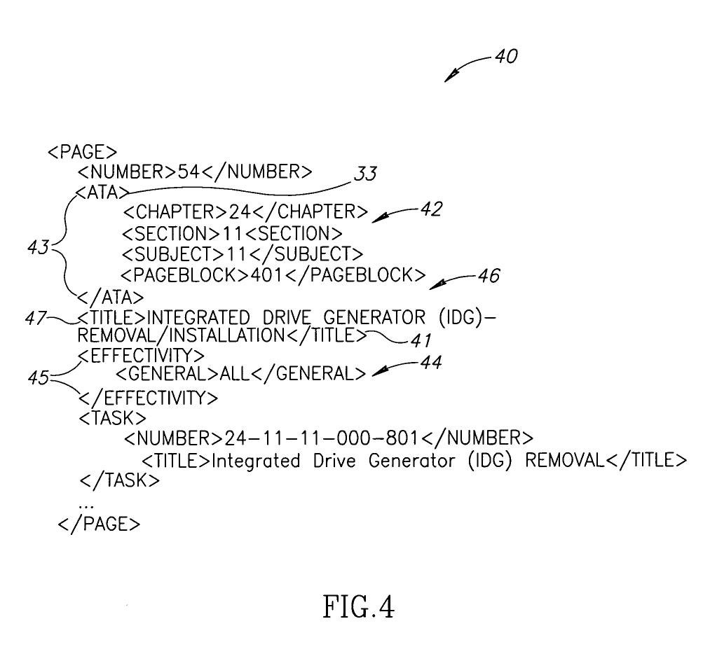

Turning now to FIG. 4, an example of a data structure 40 generated from the document 30 of FIG. 3 is shown. The data structure 40 in the present example is an XML document, although other data structure formats may also be used. The data structure 40 accordingly includes a data element 42 corresponding to the designator 32 of FIG. 3 that is positioned between corresponding start and end tags 43, a data element 44 corresponding to the effectivity block 34 of FIG. 3 having start and end tags 45, and a data element 46 having start and end tags 47 that corresponds to the title 36, as well as other data elements corresponding to other formatted entries in the document 30 of FIG. 3. The data structure 40 may also encode a plurality of different data elements extracted from a variety of documents.

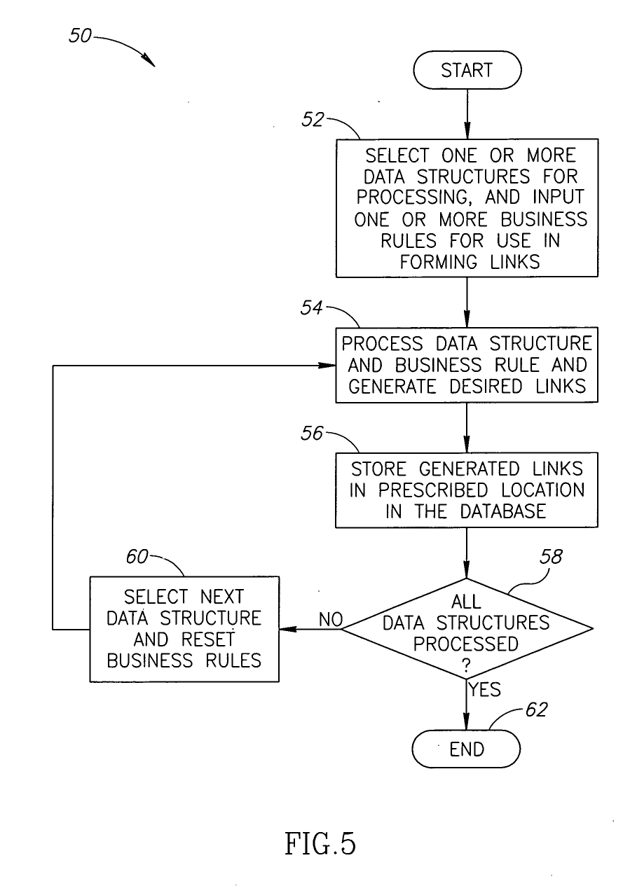

FIG. 5 is a flow chart of a method 50 of generating one or more referential document links from a data structure using one or more predetermined business rules, according to another embodiment of the invention. At block 52, one or more of the data structures 22 of FIG. 2 are selected, and the selected addresses of the data structures 22 are stored in the source information 24. The selection of the one or more data structures 22 is typically guided by the type of referential document links that are desired. For example, if it is desired that the method 50 generate referential links between one or more portions of an AMM and inspection reports pertaining to a particular component part, then a data structure generated from the AMM and another data structure generated from the inspection report documents would be selected for processing, and their respective addresses would be stored in the source information 24. Other data structures would accordingly be excluded since they do not pertain to the generation of the desired referential links. For example, financial data pertaining to the component part would not be expected to contribute useful referential links, so the data structure generated from the financial data would not be included for processing.

Block 52 also requires a business rule input. With reference again to the foregoing example, the business rule may include a manufacturer's part number for the component, a name commonly associated with the component, or any other well-defined description of the part. The one or more business rules are then stored in the business rule information 25 within the storage location 26 of FIG. 2.

At block 54, the at least one data structure 22 selected in block 52 is processed according to a first of the selected business rules stored in the business rule information 25 to generate referential document links between the at least one data structure 22 and the first of the selected business rules. At block 56, the links generated at block 54 are stored in a corresponding portion of the database 22 of FIG. 2. The links stored at block 56 may be of any form operable to form a desired association, such as a pointer to another record, or a hotspot, but in one particular embodiment, the referential document links are hyperlinks configured to link portions of hypertext documents.

At block 58, the method 50 determines if all of the selected data structures 22 have been processed. If not, a next one of the selected data structures 22 is transferred to the processor 21 for processing according to the selected business rules stored in the business rule information 25, as shown at block 60. If all of the data structures 22 have been processed, the method terminates at block 62.

In the method 50, the data structures 22 are processed sequentially. It is understood, however, that the data structures 22 may also be processed in parallel, which may advantageously accelerate the processing of the data structures 22 Further, it is understood that the selected business rules may be processed according to logical constraints. For example, the business rules may be logically related by various Boolean relations well known in the art, so that the data structures 22 may be processed according to the logically-related rules. For example, it may be desirable to process the data structures 22 by forming referential links according to one business rule while at the same time, specifically excluding another business rule (e.g., through the imposition of a .not. logical constraint). Similarly, it may be desired to form the links through a logical combination of more than one business rule, so that more than a single business rule must be present in the data structure 22 (e.g., through the imposition of an .and. logical constraint).

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A system for generating referential document links, comprising:
a first data storage location operable to store at least one data structure, the at least one data structure including data elements extracted from at least one written document;
a second data storage location operable to store at least one business rule that defines an association between data elements in the at least one data structure; and
a processor coupled to the first data storage location and the second data storage location and being configured to process the data elements in the at least one data structure and generate at least one referential link corresponding to the at least one business rule.

2. The system of claim 1, wherein at least one of the first storage location and the second storage location comprise portions of a mass storage device.

3. The system of claim 1, wherein at least one of the first storage location and the second storage location comprise a memory location in the processor.

4. The system of claim 1, wherein the second data storage location is configured to store information related to a document source.

5. The system of claim 1, further comprising a third data storage location coupled to the processor and configured to store the at least one referential link generated by the processor.

6. The system of claim 5, further comprising a link processor coupled to the third storage location operable to access the links residing in the third storage location.

7. The system of claim 1, wherein the at least one data structure stored in the first data storage location processor further comprises an XML document.

8. The system of claim 1, wherein the at least one referential link generated by the processor further comprises a hyperlink configured to link corresponding portions of a hypertext document.

9. The system of claim 1, wherein the at least one business rule stored in the second data storage location includes at least one of a placement indicator, a format indicator and a font indicator.

10. A method for generating referential document links, comprising:
selecting at least one business rule that describes a selected attribute of a written document;
processing at least one data structure to generate at least one referential link corresponding to the selected business rule; and
storing the at least one referential link in a database.

11. The system of claim 10, wherein selecting at least one business rule further comprises storing the business rule in a selected storage location.

12. The method of claim 11, further comprising storing information related to a document source in the selected storage location.

13. The method of claim 10, further comprising a link processor coupled to the database, and wherein storing the at least one referential link in a database comprises accessing the database to view the referential link.

14. The method of claim 10, wherein processing at least one data structure further comprises processing an XML document to generate at least one referential link.

15. The method of claim 10, wherein processing at least one data structure further comprises generating a hyperlink configured to link corresponding portions of a hypertext document.

16. The method of claim 10, wherein the at least one business rule stored in the second data storage location includes at least one of a placement indicator, a format indicator and a font indicator.

17. The method of claim 10, wherein selecting at least one business rule further comprises selecting a business rule that includes at least one of a placement indicator, a format indicator and a font indicator.

18. A method for generating referential document links from a data structure, comprising:
identifying at least one business rule corresponding to a selected attribute of a written document;
providing information indicating a desired subject matter area;
generating at least one referential link from the data structure corresponding to the identified business rule and the information indicating a desired subject matter area; and
transferring the at least one referential link to a storage device.

19. The method of claim 18, wherein identifying at least one business rule corresponding to a selected attribute of a written document further comprises storing the business rule in a storage location within the storage device.

20. The method of claim 18, wherein providing information indicating a desired subject matter area further comprises storing the information in a storage location within the storage device.

21. The method of claim 18, further comprising a link processor coupled to the storage device, and wherein transferring the at least one referential link comprises accessing the storage device to view the referential link.

22. The method of claim 18, wherein generating at least one referential link from the data structure includes processing an XML document.

23. The method of claim 18, wherein generating at least one referential link from the data structure further comprises generating a hyperlink configured to link corresponding portions of a hypertext document.

24. The method of claim 18, wherein identifying at least one business rule further comprises selecting a business rule that includes at least one of a placement indicator, a format indicator and a font indicator.

25. The method of claim 18, further comprising accessing the at least one referential link from the storage device.

26. The method of claim 25, wherein accessing the at least one referential link further comprises viewing the referential link on a display device.

27. The method of claim 25, wherein accessing the at least one referential link further comprises incorporating the referential link into a document.

28. A method of developing referential document links for an aircraft maintenance document, comprising:
selecting at least one business rule corresponding to a selected attribute of the aircraft maintenance document;
accessing a database that includes a plurality of data structures formatted as XML documents;
selecting a portion of the data structures related to a maintenance topic of interest;
generating at least one referential link from the selected portions; and
transferring the at least one referential link to a database.

29. The method of claim 28, wherein selecting at least one business rule corresponding to a selected attribute of the aircraft maintenance document further comprises storing the at least one business rule in a storage location within the database.

30. The method of claim 28, wherein selecting a portion of the data structures related to a maintenance topic of interest further comprises providing information related to the topic of interest.

31. The method of claim 30, wherein providing information related to the topic of interest further comprises storing the information in a storage location within the database.

32. The method of claim 28, further comprising a link processor coupled to the database, and wherein transferring the at least one referential link further comprises accessing the database to view the referential link.

33. The method of claim 28, further comprising a link processor coupled to the database, and wherein transferring the at least one referential link further comprises incorporating the at least one referential link into a maintenance document.

34. The method of claim 28, wherein generating at least one referential link from the selected portions further comprises generating a hyperlink configured to link corresponding portions of a hypertext document.

35. The method of claim 28, wherein selecting at least one business rule corresponding to a selected attribute of the aircraft maintenance document further comprises selecting a business rule that includes at least one of a placement indicator, a format indicator and a font indicator.
